(19) United States
(12) Patent Application Publication
(10) Pub. No.: US 2025/0371738 A1
(43) Pub. Date: Dec. 4, 2025

(54) CALIBRATION METHOD

(71) Applicant: SONY GROUP CORPORATION, Tokyo (JP)

(72) Inventors: Ryuichi TADANO, Tokyo (JP); Hideki OYAIZU, Tokyo (JP)

(21) Appl. No.: 18/876,299

(22) PCT Filed: Jun. 12, 2023
(86) PCT No.: PCT/JP2023/021692

§ 371 Date: Dec. 18, 2024

(30) Foreign Application Priority Data
Jun. 27, 2022 (JP) 2022-102734

(51) Int. Cl. G06T 7/80; G02F 1/133; G02F 1/1335

(52) U.S. Cl. CPC G06T 7/80; G02F 1/13306; G02F 1/133528

(57) ABSTRACT

The present disclosure relates to a calibration method that makes it possible to facilitate angle-of-view change and lens interchange in spectral imaging using a liquid crystal device and a polarizing element. In a spectral imaging system in which a lens condenses incident light from a scene, and a liquid crystal device and a polarizing element generate a spectral image on the basis of a plurality of modulated images generated by modulating the incident light transmitting through the lens while changing an applied voltage to the liquid crystal device, calibration data is generated for a target lens to be calibrated that matches observation information corresponding to spectral information generated with use of the target lens with spectral information generated with use of a known lens. The present disclosure can be applied to a spectral imaging device using a liquid crystal device and a polarizing element.

### TECHNICAL FIELD

The present disclosure relates to a calibration method, and more particularly, to a calibration method enabled to facilitate angle-of-view change and lens interchange in spectral imaging using a liquid crystal device and a polarizing element.

### BACKGROUND ART

A technology for implementing spectral imaging using a liquid crystal device and a polarizing element has been proposed (see Patent Document 1).

### CITATION LIST

### Patent Document

Patent Document 1: EP 3015832 A1

### SUMMARY OF THE INVENTION

### Problems to be Solved by the Invention

In spectral imaging using a liquid crystal device and a polarizing element, since angle dependence of the liquid crystal device is high, an incident angle is limited or calibration is performed according to an optical system to be used, that is, a lens to be used.

However, since different calibration data is required for each lens, the lens has not been easily changed.

Furthermore, even with the same lens, when an angle of view changes due to zooming, a relationship between a position in a screen and the incident angle changes, and thus, it has not been possible to support dynamic angle-of-view change.

The present disclosure has been made in view of such a situation, and in particular, the present disclosure facilitates lens interchange in spectral imaging using a liquid crystal device and a polarizing element, and supports dynamic angle-of-view change in conjunction with change in focal length due to zooming.

### Solutions to Problems

A calibration method of one aspect of the present disclosure is a calibration method for a spectral imaging system that generates spectral information with use of a lens, a liquid crystal device, and a polarizing element, the calibration method including a step of generating calibration data for a target lens that is the lens to be calibrated, the calibration data matching observation information corresponding to the spectral information generated with use of the target lens with a true value of the spectral information.

In one aspect of the present disclosure, with a calibration method for a spectral imaging system that generates spectral information with use of a lens, a liquid crystal device, and a polarizing element, calibration data is generated for a target lens that is the lens to be calibrated, the calibration data matching observation information corresponding to the spectral information generated with use of the target lens with a true value of the spectral information.

### BRIEF DESCRIPTION OF DRAWINGS

FIG. 1 is a diagram illustrating a principle of spectral imaging using a liquid crystal device and a polarizing element.

FIG. 2 is a diagram illustrating an example of visualization of an observation matrix used in the spectral imaging using the liquid crystal device and the polarizing element.

FIG. 3 is a diagram illustrating angle dependence of the liquid crystal device.

FIG. 4 is a diagram illustrating an influence caused by a difference in lens in the spectral imaging using the liquid crystal device and the polarizing element.

FIG. 5 is a diagram illustrating an influence caused by a difference in angle of view in the spectral imaging using the liquid crystal device and the polarizing element.

FIG. 6 is a diagram illustrating a configuration example of a preferred embodiment of a spectral imaging system of the present disclosure.

FIG. 7 is a diagram illustrating a difference between standard liquid crystal retardance characteristic and calibration data.

FIG. 8 is a diagram illustrating a configuration example of a chart with a marker.

FIG. 9 is a diagram illustrating an imaging example of a chart in a case where an angle of view of a target lens is wider than an angle of view of a known lens.

FIG. 10 is a flowchart illustrating calibration processing by the spectral imaging system in FIG. 6.

FIG. 11 is a flowchart illustrating spectral imaging processing by the spectral imaging system in FIG. 6.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference signs, and redundant description is omitted.

Hereinafter, modes for carrying out the present technology will be described. The description will be given in the following order.
1. Outline of Present Disclosure
2. Preferred Embodiment

### 1. Outline of Present Disclosure

### <Principle of Spectral Imaging Using Liquid Crystal Device and Polarizing Element>

The present disclosure facilitates lens interchange in spectral imaging using a liquid crystal device and a polarizing element, and supports dynamic angle-of-view change in conjunction with change in focal length due to zooming.

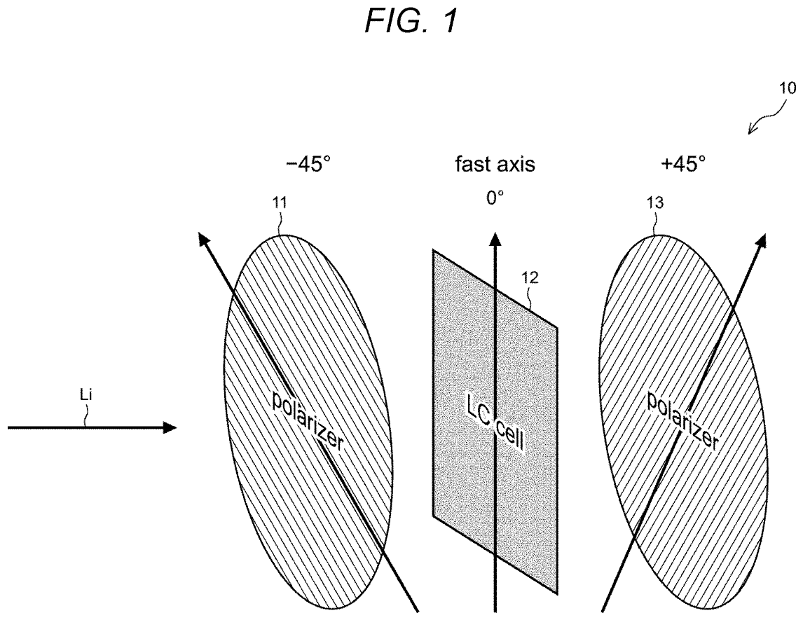

Thus, first, with reference to FIG. 1, a description will be given of a principle of the spectral imaging using the liquid crystal device and the polarizing element.

The liquid crystal device is known to have birefringence having a refractive index (light traveling speed) different depending on a polarization direction of incident light.

That is, when light is incident on the liquid crystal device that is a substance having the birefringence, a refractive index varies depending on a polarization direction (direction of a vibration surface), and thus a traveling speed varies.

Here, a polarization direction in which light travels relatively fast (low refractive index nₑ) is referred to as a fast axis, and a polarization direction in which light travels slow (high refractive index nₒ) is referred to as a slow axis.

Then, a birefringence index is defined by a difference Δn (=nₑ−nₒ) between the refractive index nₑ of the fast axis and the refractive index nₒ of the slow axis.

The birefringence index of the liquid crystal device can be controlled by a voltage v applied to the liquid crystal device, and can be expressed as Δn(v). The liquid crystal device including the substance having the birefringence changes incident light of linearly polarized light into elliptically polarized light or circularly polarized light and transmits the elliptically polarized light or circularly polarized light.

The principle of the spectral imaging using the liquid crystal device and the polarizing element using such a characteristic is implemented by a spectral optical block as illustrated in FIG. 1.

Note that a spectral optical block 10 in FIG. 1 includes a polarizing element (polarizer) 11, a liquid crystal device (LC cell) 12, and a polarizing element (polarizer) 13, and the polarizer 11, the liquid crystal device (LC cell) 12, and the polarizer 13 are arranged in this order from an incident direction of incident light Li with surfaces thereof in parallel to each other.

The polarizing element 11 is arranged at a front stage of the liquid crystal device 12 and in a state of being rotated by −45° with respect to the fast axis of the liquid crystal device 12, and transmits polarized light in a direction of −45° with respect to the fast axis of the liquid crystal device 12.

Furthermore, the polarizing element 13 is arranged at a rear stage of the liquid crystal device 12 and in a state of being rotated by +45° with respect to the fast axis of the liquid crystal device 12, and transmits polarized light in a direction of +45° with respect to the fast axis of the liquid crystal device 12.

By the spectral optical block 10 having the configuration as illustrated in FIG. 1, it is possible to apply wavelength-dependent modulation as expressed by Expression (1) below to the incident light Li.

$$\begin{matrix}[ Math . 1 ] & \\ f ( λ ) = \frac{1}{2} ( 1 - cos ( 2 π \frac{△ n ( v ) {d}_{LC}}{λ} ) ) & ( 1 )\end{matrix}$$

Here, f(λ) represents a wavelength modulation characteristic, λ represents a wavelength, Δn(v) represents a birefringence index of the liquid crystal device 12, v represents an applied voltage to the liquid crystal device 12, and d_{LC} represents a thickness of the liquid crystal device 12.

By using the wavelength modulation characteristic expressed by Expression (1) to measure observation information that is a plurality of times of results of transmission through the spectral optical block 10 while changing the voltage v applied to the liquid crystal device 12, it is possible to acquire observation information subjected to different modulation, and it is possible to acquire a spectral image (spectral information) of the incident light Li on the basis of the observation information.

That is, for example, when spectral information including each pixel value of a spectral image of a scene including a measurement target is defined as a p-dimensional column vector X, wavelength modulation characteristics at q different voltages v are defined as a p×q observation matrix A, and observation information measured at q voltages v is defined as a vector Y, expression can be performed by Expression (2) below.

$$\begin{matrix}[ Math . 2 ] & \\ Y = AX & ( 2 )\end{matrix}$$

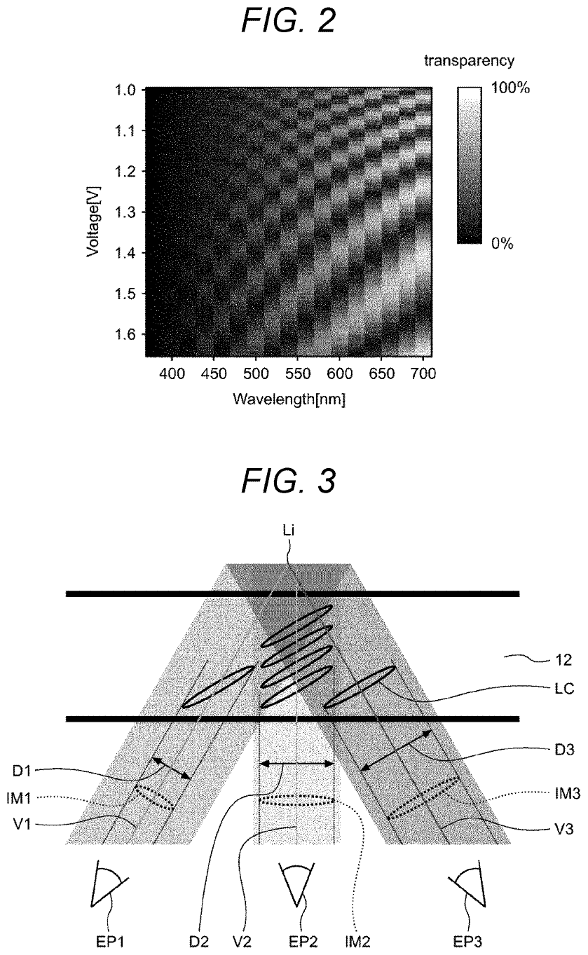

Note that, when elements constituting the observation matrix A are visualized with use of transmittances, expression can be performed as illustrated in FIG. 2.

In FIG. 2, the vertical axis represents the applied voltage v (Voltage [V]) applied to the liquid crystal device 12, and the horizontal axis represents the wavelength A (Wavelength [nm]) of the incident light, and FIG. 2 indicates that white portions have higher transmittance (transparency), and black portions have lower transmittance (transparency).

Since the observation matrix A can be set to known information by calibration or a physical model, the spectral information X can be easily solved on the basis of the observation matrix A and the observation information Y.

For example, by using Tikhonov regularization method, the spectral information X can be solved as expressed by Expression (3) below.

$$\begin{matrix}[ Math . 3 ] & \\ X = {( {A}^{T} A + α I )}^{- 1} {A}^{T} Y & ( 3 )\end{matrix}$$

Here, α is a regularization parameter, and I is an identity matrix.

That is, according to the above-described principle, it is possible to obtain the spectral information X by solving Expression (3) using the observation matrix A by matrix operation on the basis of the observation information Y observed with use of the spectral optical block 10 as illustrated in FIG. 1.

### <Angle Dependence of Liquid Crystal Device>

Liquid crystal constituting the liquid crystal device 12 is a substance in a state between a solid and a liquid, and as an internal structure, elliptical liquid crystal molecules close to a rod shape are arranged in a substantially constant direction according to an applied voltage, that is, with alignment according to the applied voltage.

The major axis direction of the liquid crystal molecules is an optical abnormal axis, and the liquid crystal molecules have a relatively high refractive index (have a characteristic that the light traveling speed is slow); however, as illustrated in FIG. 3, appearance of the liquid crystal molecules varies depending on an incident angle of the incident light Li with respect to the liquid crystal device 12, and accordingly, an effective refractive index also has dependency on the incident angle.

FIG. 3 is a diagram illustrating how liquid crystal molecules LC appear in each of three types of incident directions V1 to V3 having different incident angles of the incident light Li to the liquid crystal device 12.

That is, as illustrated in FIG. 3, the liquid crystal molecules LC in the liquid crystal device 12 are arranged in a substantially constant direction, that is, with alignment according to the applied voltage.

For this reason, when the incident light Li is incident on the liquid crystal device 12 from the incident direction V1, the liquid crystal molecules LC are observed as an image IM1 having a major axis diameter D1 as viewed from a viewpoint EP1 in front in the incident direction V1.

Furthermore, when the incident light Li is incident on the liquid crystal device 12 from the incident direction V2, the liquid crystal molecules LC are observed as an image IM2 having a major axis diameter D2 (>D1) as viewed from a viewpoint EP2 in front in the incident direction V2.

Moreover, when the incident light Li is incident on the liquid crystal device 12 from the incident direction V3, the liquid crystal molecules LC are observed as an image IM3 having a major axis diameter D3 (>D2>D1) as viewed from a viewpoint EP3 in front in the incident direction V3.

As described above, in the viewpoints EP1 to EP3 corresponding to the incident directions V1 to V3 of the incident light Li, the appearance of the liquid crystal molecules LC varies as the images IM1 to IM3 of the major axis diameters D3, D2, and D1, and thus the effective refractive index of the liquid crystal device 12 also has angle dependence on the incident angle of the incident light Li.

### <Influence of Difference in Lens>

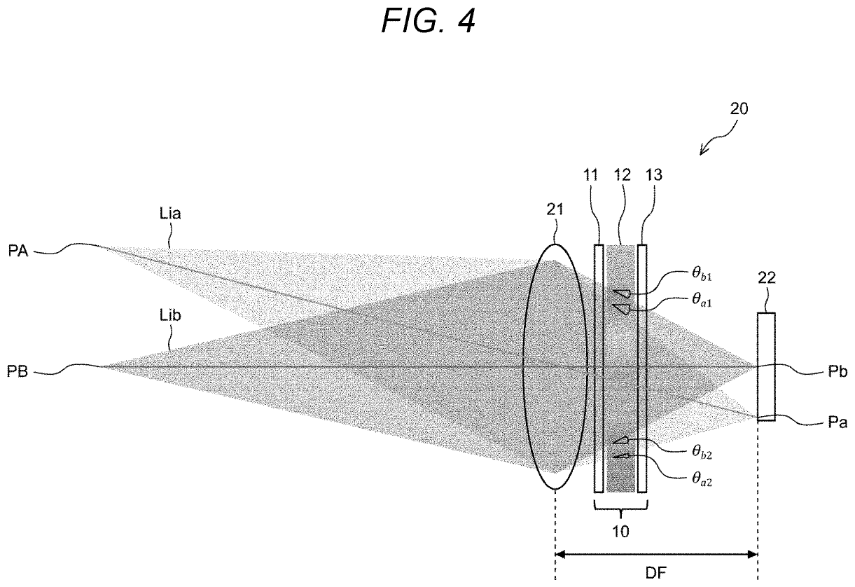

Next, with reference to FIG. 4, a description will be given of an influence caused by a difference in lens in a spectral imaging system implemented with application of the spectral optical block 10 described above.

Here, in describing the influence caused by the difference in lens, for example, as illustrated in FIG. 4, a spectral imaging system 20 is considered in which a lens 21 is provided at a front stage and an imaging element 22 is added at a rear stage with respect to the spectral optical block 10 in FIG. 1.

In the spectral imaging system 20 of FIG. 4, incident light Lia and incident light Lib from a light source PA and a light source PB on a subject side is transmitted through the spectral optical block 10 through the lens 21 to be condensed and focused on a pixel Pa and a pixel Pb on the imaging element 22.

An angle of a light beam passing through the liquid crystal device 12 of the spectral optical block 10 varies depending on an image height in an image captured by the imaging element 22.

More specifically, the incident light Lia focused on the pixel Pa is incident on the liquid crystal device 12 in a range from an incident angle θₐ₁ to an incident angle θₐ₂.

Furthermore, the incident light Lib focused on the pixel Pb on the imaging element 22 is incident on the liquid crystal device 12 in a range from an incident angle θ_{b1} to an incident angle θ_{b2}.

That is, as in the pixels Pa and Pb on the imaging element 22, when the image height changes, the birefringence index also changes.

As described above, since the effective birefringence index of the liquid crystal device 12 has the angle dependence of the incident light, when the incident angle changes due to the image height on the imaging element 22, the birefringence index also changes according to the change in the incident angle, and as a result, the observation matrix for obtaining the spectral image also changes according to the image height.

### <Influence of Difference in Angle of View>

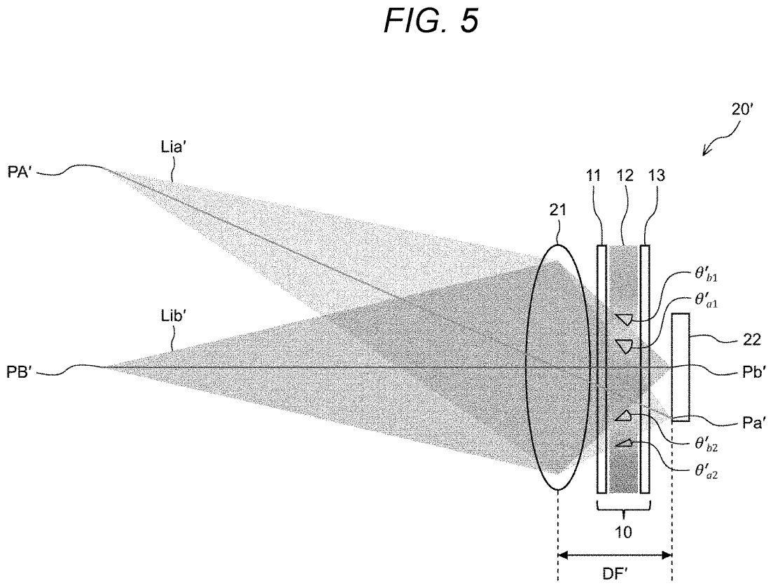

Next, with reference to FIG. 5, a description will be given of an influence caused by a difference in angle of view in the spectral imaging system implemented with application of the spectral optical block 10 described above.

In a spectral imaging system 20′ of FIG. 5, incident light Lia′ and incident light Lib′ from a light source PA′ and a light source PB′ on the subject side are transmitted through the spectral optical block 10 through the lens 21 to be condensed and focused on a pixel Pa′ and a pixel Pb′ on the imaging element 22.

An angle of a light beam passing through the liquid crystal device 12 of the spectral optical block 10 varies depending on an image height in an image captured by the imaging element 22.

More specifically, the incident light Lia′ focused on the pixel Pa′ is incident on the liquid crystal device 12 in a range from an incident angle θ′ₐ₁ to an incident angle θ′ₐ₂.

Furthermore, the incident light Lib′ focused on the pixel Pb′ on the imaging element 22 is incident on the liquid crystal device 12 in a range from an incident angle θ′_{b1} to an incident angle θ′_{b2}.

That is, as in the pixels Pa′ and Pb′ on the imaging element 22, when the image height changes, the birefringence index also differs.

Moreover, in FIG. 4, a distance between the lens 21 and the imaging element 22, that is, the focal length is DF, while the focal length is DF′ (<DF (FIG. 4)) in FIG. 5.

For this reason, the pixels Pa′ and Pa on the imaging element 22 have the same image height, but optical paths of the incident light Lia and the incident light Lia′ are different from each other, and thus the incident angles on the liquid crystal device 12 are also different from each other, which are in the range from the incident angle θₐ₁ to the incident angle θₐ₂ and in the range from the incident angle θ′ₐ₁ to the incident angle θ′ₐ₂.

Similarly, the pixels Pb′ and Pb on the imaging element 22 have image heights that are the center positions of the same imaging element 22, but optical paths of the incident light Lib and the incident light Lib′ are different from each other, and thus the incident angles on the liquid crystal device 12 are also different from each other, which are in the range from the incident angle θₐ₁ to the incident angle θₐ₂ and in the range from the incident angle θ′ₐ₁ to the incident angle θ′ₐ₂.

Thus, the birefringence index changes according to not only the change in the incident angle due to the image height on the imaging element 22 but also the change in the focal length that is the distance between the lens 21 and the imaging element 22, that is, the change in the angle of view, and as a result, the observation matrix for obtaining the spectral information also changes according to the image height and the angle of view.

Thus, in the spectral imaging using the liquid crystal device and the polarizing element, when a spectral image is to be obtained, it is necessary to obtain the observation matrix in advance by calibration for the focal length of the lens 21 in addition to the image height on the imaging element 22.

In particular, it is necessary to pay attention to the fact that the range of the incident angle of the incident light changes when the focal length is different even at the center position on the imaging element 22 as in the pixels Pb and Pb′, and unlike a case where only a relationship between a point on the subject and an image formation position needs to be considered as in lens distortion correction or the like in a normal camera, it is more susceptible to an influence of the optical progress (influence of a change in the optical path of the incident light).

Thus, in the spectral imaging using the liquid crystal device and the polarizing element of the present disclosure, calibration of an unknown target lens is executed with use of a known lens (calibrated lens) and a chart. Note that, hereinafter, a calibrated lens is referred to as a known lens, and a lens to be calibrated is referred to as a target lens.

More specifically, in each of a state in which the known lens is mounted and a state in which the target lens is mounted, the same chart is imaged under the same environment, and calibration data is generated for converting an imaging result (observation information) by the target lens into an imaging result (spectral information) by the known lens.

Then, at the time of spectral imaging using the target lens, it is made possible to generate an appropriate imaging result (spectral imaging) using the target lens by adjusting the imaging result with use of the calibration data.

Work related to the calibration only needs to image the same chart while changing the applied voltage to the liquid crystal device and the focal length in states where the known lens and the target lens are respectively mounted.

For this reason, it is possible relatively easily to implement lens interchange in the spectral imaging using the liquid crystal device and the polarizing element, and to support dynamic angle-of-view change in conjunction with the change in the focal length due to zooming.

### 2. Preferred Embodiment

### <Configuration Example of Imaging Device of Present Disclosure>

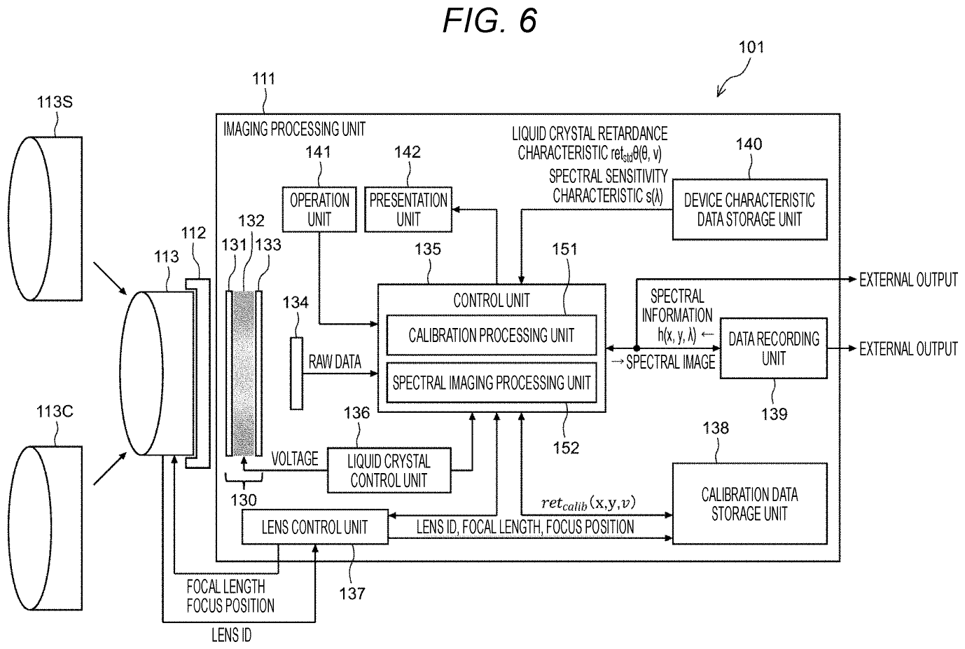

Next, with reference to FIG. 6, a description will be given of a configuration example of a preferred embodiment of the spectral imaging system of the present disclosure.

A spectral imaging system 101 in FIG. 6 is a configuration for implementing spectral imaging, and includes an imaging processing unit 111, a lens mount 112, and a lens 113.

The spectral imaging system 101 has a configuration similar to that of a interchangeable lens camera, and has a configuration in which the lens 113 can be attached and detached through the lens mount 112, and thus has a configuration capable of interchanging with the lenses 113 having various optical characteristics.

Note that, in FIG. 6, as an example of the lens 113 that is interchangeable, drawn are a known lens 113S that is a lens whose lens characteristic is known (calibrated lens) and a target lens 113C that is a lens to be calibrated whose lens characteristic is unknown, and it is expressed that both lenses are mountable on the lens mount 112 and interchangeable.

The imaging processing unit 111 has a configuration corresponding to a camera body in a so-called interchangeable lens camera, implements spectral imaging on the basis of information on a scene including a measurement target incident through the lens 113, and temporarily records a spectral image as an imaging result in a data recording unit 139 and outputs the spectral image to the outside or directly outputs the spectral image to the outside.

The imaging processing unit 111 executes calibration processing of generating calibration data for implementing spectral imaging using the target lens 113C to be calibrated.

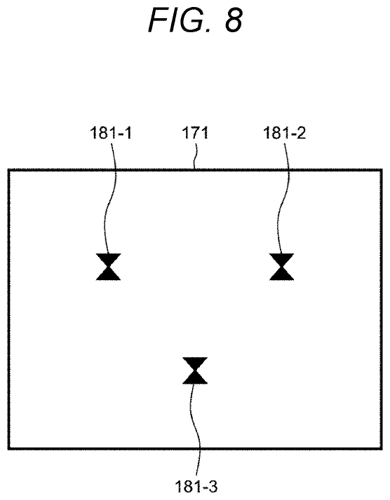

In the calibration processing, the imaging processing unit 111 images a chart 171 (FIG. 8) in states where the known lens 113S and the target lens 113C are respectively mounted on the lens mount 112, and generates and stores calibration data that can convert an imaging result by the target lens 113C into an imaging result by the known lens 113S on the basis of both imaging results.

Then, when spectral imaging is performed in the state where the target lens 113C is mounted on the lens mount 112, the imaging processing unit 111 converts (corrects) the imaging result on the basis of the calibration data to generate and output a spectral image.

Note that a method for generating calibration data will be described later in detail.

The imaging processing unit 111 includes a spectral optical block 130 including a polarizing element 131, a liquid crystal device 132, and a polarizing element 133, an imaging element 134, a control unit 135, a liquid crystal control unit 136, a lens control unit 137, a calibration data storage unit 138, the data recording unit 139, a device characteristic data storage unit 140, an operation unit 141, and a presentation unit 142.

The spectral optical block 130 including the polarizing element 131, the liquid crystal device 132, and the polarizing element 133 has the same configuration as the spectral optical block 10 including the polarizing element (polarizer) 11, the liquid crystal device (LC cell) 12, and the polarizing element (polarizer) 13 in FIG. 1.

The imaging element 134 includes a complementary metal oxide semiconductor (CMOS) image sensor, a charge coupled device (CCD) image sensor, or the like, captures an image including modulated light obtained with application of modulation by the spectral optical block 130 to incident light from the scene including the measurement target, as a modulated image, generates RAW data on the basis of pixel signals in units of pixels, and outputs the RAW data to the control unit 135.

The control unit 135 controls entire operation of the imaging processing unit 111, performs various types of signal processing on the pixel signals of the modulated image supplied from the imaging element 134 to generate calibration data, and implements spectral imaging by using the generated calibration data.

In the calibration processing, the control unit 135 generates calibration data on the basis of a modulated image including RAW data supplied from the imaging element 134 and stores the calibration data in the calibration data storage unit 138.

In the spectral imaging processing, the control unit 135 reads calibration data from the calibration data storage unit 138 on the basis of a modulated image including RAW data supplied from the imaging element 134, performs processing on the modulated image, and generates and outputs a spectral image.

More specifically, the control unit 135 includes a calibration processing unit 151 and a spectral imaging processing unit 152.

In the calibration processing, the calibration processing unit 151 obtains a spectral image on the basis of the modulated image by the imaging element 134 in a state where the known lens 113S is mounted, and records, in the data recording unit 139, the spectral image as spectral information h(x, y, λ) necessary for calibration.

Note that, in the present specification, the spectral image obtained on the basis of the modulated image captured by the imaging element 134 in the state where the known lens 113S is mounted is information necessary for generating calibration data, and thus is particularly expressed as the spectral information h(x, y, λ).

In other words, the spectral information h(x, y, λ) necessary for generating the calibration data is expressed separately from a spectral image finally generated on the basis of the modulated image captured by the imaging element 134 in a state where a lens other than the known lens 113S, that is, the target lens 113C is mounted and the calibration data.

The calibration processing unit 151 generates calibration data ret_{calib}(x, y, v) on the basis of: the spectral information h(x, y, λ) when the known lens 113S is mounted, recorded in the data recording unit 139, on the basis of the modulated image by the imaging element 134 in the state where the target lens 113C is mounted; a standard liquid crystal retardance characteristic ret_{std}(θ, v) and a spectral sensitivity characteristic s(λ) of the imaging element 134 stored in the device characteristic data storage unit 140; and the applied voltage v to the liquid crystal device 132 supplied from the liquid crystal control unit 136, and stores the calibration data in the calibration data storage unit 138.

In the spectral imaging processing, the spectral imaging processing unit 152 reads the calibration data ret_{calib}(x, y, v) from the calibration data storage unit 138 and performs signal processing on the modulated image from the imaging element 134 in the state where the target lens 113C is mounted, to generate a spectral image, temporarily records the spectral image in the data recording unit 139, and outputs the spectral image to the outside, or directly outputs the spectral image to the outside.

The liquid crystal control unit 136 controls an applied voltage to be applied to the liquid crystal device 132, and is controlled by the control unit 135 to change the applied voltage v and apply it to the liquid crystal device 132, and outputs information of the applied voltage v applied to the liquid crystal device 132 to the control unit 135.

The lens control unit 137 is controlled by the control unit 135, communicates with the lens 113 mounted on the lens mount 112, acquires a lens ID for individually identifying the lens 113 stored in a storage unit (not illustrated) built in the lens 113, and adjusts a focal length and a focus position.

Then, the lens control unit 137 supplies information of the acquired lens ID, the focal length and the focus position of the current lens 113, to the calibration data storage unit 138.

The calibration data storage unit 138 includes a hard disk drive (HDD), a solid state drive (SSD), a semiconductor memory, or the like, and stores the calibration data ret_{calib}(x, y, v) supplied from the calibration processing unit 151 of the control unit 135.

At this time, the calibration data storage unit 138 stores the calibration data ret_{calib}(x, y, v) in association with the information of the lens ID, the focal length, and the focus position of the currently mounted target lens 113C, supplied from the lens control unit 137.

Furthermore, in the spectral imaging processing, the calibration data storage unit 138 supplies the calibration data ret_{calib} (x, y, v) stored in association with the lens ID, the focal length, and the focus position of the currently mounted target lens 113C to the spectral imaging processing unit 152 of the control unit 135.

The data recording unit 139 includes an HDD, an SSD, a semiconductor memory, or the like, and temporarily stores the spectral information h(x, y, λ) captured in the state where the known lens 113S is mounted, in the calibration processing.

Furthermore, in the spectral imaging processing, the data recording unit 139 temporarily stores the spectral image generated in the state where the target lens 113C is mounted, supplied from the control unit 135, and outputs the spectral image to the outside, as necessary.

The device characteristic data storage unit 140 includes an HDD, an SSD, a semiconductor memory, or the like, stores the standard liquid crystal retardance characteristics ret_{std}(θ, v) and the spectral sensitivity characteristics s(λ) of the imaging element 134 stored in the device characteristic data storage unit 140, and supplies the same to the calibration processing unit 151 of the control unit 135, as necessary.

The operation unit 141 includes a shutter button operated by a user at the time of imaging, a keyboard, a touch panel, and the like for performing operation input of various types of information, and supplies a signal corresponding to the operation input to the control unit 135. For example, in a case where the lens control unit 137 cannot acquire the lens ID from the lens 113 by communication, the user may operate the operation unit 141 to input the lens ID.

The presentation unit 142 is, for example, a display unit including a display or the like, or an audio output unit including a speaker or the like, is controlled by the control unit 135, and presents information required for proceeding with the calibration processing or the like to the user with an image or sound.

The presented information is, for example, information for prompting interchange and mounting of the known lens 113S and the target lens 113C or information for prompting imaging the chart 171 (FIG. 8) to be fit into the angle of view, according to various states in the calibration processing.

### <Method for Generating Calibration Data>

Next, a method for generating the calibration data ret_{calib}(x, y, v) will be described.

The calibration data is a value corresponding to a retardance (phase difference) at each spatial coordinate and voltage, which matches the spectral image (observation information) generated when a target optical system (here, the target lens 113C) is mounted with a true value of the spectral image (spectral information).

For example, when a spectral image generated on the basis of a modulated image captured by the imaging element 134 in the state where the target lens 113C is mounted on the lens mount 112 is expressed as observation information i(x, y, v), the spectral image is expressed by Expression (4) below.

$$\begin{matrix}[ Math . 4 ] & \\ i ( x , y , v ) = \frac{1}{2} {\int }_{λ} h ( x , y , λ ) ( 1 - cos ( 2 π \frac{△ n ( x , y , v ) {d}_{LC}}{λ} ) ) s ( λ ) d λ & ( 4 )\end{matrix}$$

Here, (x, y) are coordinates on the modulated image to be the imaging result by the imaging element 134, h(x, y, λ) is spectral information (a true value of the spectral information) obtained on the basis of the modulated image when the known lens 113S is mounted, s(λ) is a spectral sensitivity characteristic of the imaging element 134, Δn(x, y, v) is a birefringence index of the coordinates (x, y) on the modulated image at the voltage v, and d_{LC} is a thickness of the liquid crystal device 132. Note that, here, an example will be described in which the spectral information obtained on the basis of the modulated image when the known lens 113S is mounted is set as the true value of the spectral information; however, the true value of the spectral information may be other than this, and may be, for example, spectral information measured by another measuring instrument, spectral information obtained when a subject having a known spectral characteristic is used, or the like.

Among them, the spectral information h(x, y, λ) obtained from the modulated image when the known lens 113S is mounted is information when the known lens 113S is mounted, and thus can be known information. Furthermore, the spectral sensitivity characteristic s(λ) of the imaging element 134 can also be known information.

Moreover, the thickness d_{LC} of the liquid crystal device 132 is a fixed value, and thus can be known information.

Thus, the value to be obtained as the calibration data is the birefringence index Δn(x, y, v).

Meanwhile, in the liquid crystal device 132, the characteristic of the phase difference between the fast axis and the slow axis of the incident light is known as a standard liquid crystal retardance characteristic ret_{std}Δ(θ, v)=Δn(v)·d_{LC} determined from an incident angle θ and the applied voltage v, and is known information.

Furthermore, the liquid crystal retardance characteristic is defined as a value obtained by multiplication of the birefringence index Δn(v) by the thickness d_{LC} of the liquid crystal device 132.

Thus, in the present disclosure, data Δn(x, y, v)·d_{LC} corresponding to the liquid crystal retardance in the state where the target lens 113C is mounted is treated as the calibration data ret_{calib}(x, y, v) (=Δn(x, y, v)·d_{LC}).

As a result, in the calibration processing of the present disclosure, the calibration data ret_{calib}(x, y, v) satisfying the relationship of Expression (4) described above is obtained.

Then, in the spectral imaging processing, the spectral image is generated by an operation using the observation matrix corresponding to Expression (3) described above on the basis of the coordinates (x, y) on the modulated image in the state where the target lens 113C is mounted and the applied voltage v to the liquid crystal device 132 with use of the calibration data ret_{calib}(x, y, v) obtained in the calibration processing.

At this time, the observation matrix using the calibration data ret_{calib}(x, y, v) is expressed as, for example, Expression (5) below.

$$\begin{matrix}[ Math . 5 ] & \\ {A}_{x , y} ( v , λ ) = \frac{1}{2} ( 1 - cos ( 2 π \frac{{ret}_{calib} ( x , y , v )}{λ} ) ) s ( λ ) & ( 5 )\end{matrix}$$

Here, A_{x,y}(v, λ) is a matrix element of the applied voltage v of the observation matrix A including voltage wavelength modulation characteristics using the calibration data ret_{calib} (x, y, v). Note that, hereinafter, in a case where it is necessary to distinguish A_{x,y}(v, λ) as an individual element of the observation matrix A, the element is referred to as an observation matrix element A_{x,y}(V, λ), and in a case where it is not necessary to distinguish, the observation matrix A_{x,y}(v, λ) is also used simply in the same meaning as the observation matrix A.

Here, since the birefringence index of the liquid crystal device 132 smoothly changes with respect to the incident angle of the incident light, the calibration data ret_{calib}(x, y, v) is used such that only sample points are held that are discrete with respect to a spatial direction on an imaging surface of the imaging element 134 and the focal length of the lens 113 and interpolation is performed according to an optical state to be applied.

Furthermore, information of a lens type (lens ID) and the focal length of the lens 113 may be acquired by communication between the lens 113 and the imaging processing unit 111 similarly to communication (lens-camera communication) between a lens and a camera put into practical use in an interchangeable lens camera or the like, or may be input by the user operating the operation unit 141 in accordance with an imaging state.

That is, after the calibration processing is performed once, in a case where the lens-camera communication can be used, the user can maintain an optimum calibration state without being conscious of the information on the lens 113 only by mounting the desired lens 113 on the lens mount 112.

Note that the known standard liquid crystal retardance characteristic ret_{std}Δ(θ, v) is defined as a characteristic of the liquid crystal device 132 with respect to one optical path (principal ray) of the incident angle θ, but the calibration data ret_{calib}(x, y, v) (=Δn(x, y, v)·d_{LC}) is defined as a characteristic with respect to all optical paths condensed on a coordinate position (x, y) of a pixel P on the corresponding imaging element 134.

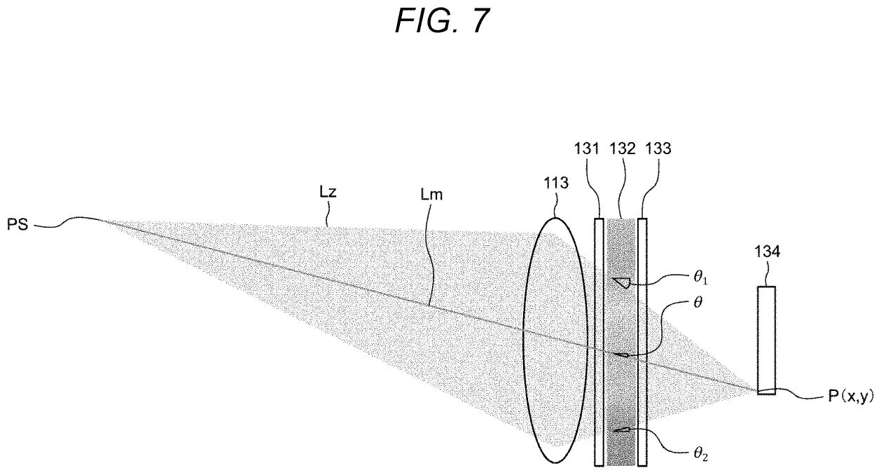

Here, a relationship between the coordinate position (x, y) of the pixel P on the imaging element 134 and the incident angle θ of a principal ray Lm is illustrated in FIG. 7, and can be a one-to-one relationship by combination with optical parameters such as the focal length, the focus position, and the lens distortion data of the lens 113.

For this reason, it is conceivable to regard that a relationship of the calibration data ret_{calib}(x, y, v)=the standard liquid crystal retardance characteristic ret_{std}(θ, v) is established, but this relationship is not strictly established.

This is because, as illustrated in FIG. 7, incident light from a light source PS incident on the pixel P located at the coordinate position (x, y) on the imaging element 134 is condensed by the lens 113, so that the incident light is actually all incident light Lz in a range from an incident angle θ₁ to an incident angle θ₂ with respect to the liquid crystal device 132 (incident light of all optical paths in a range shaded in the figure).

Furthermore, in a case where lens parameters cannot be accurately grasped, the incident angle θ with respect to the coordinate position (x, y) of the pixel P is an approximate value, and thus, also in that case, a relationship of ret_{calib}(x, y, v)≠ret_{std}(θ, v) is established, and calibration is required.

However, it is possible to regard that a relationship of ret_{calib}(x, y, v)≈ret_{std}(θ, v) is established, and it can be assumed that a difference between the two changes only gently with respect to a voltage change.

Under such a regularization condition, the calibration data ret_{calib}(x, y, v) that satisfies the relationship expressed by Expression (4) described above is obtained at each voltage v, whereby the calibration can be implemented.

Moreover, since it is possible to regard that a relationship of ret_{calib}(x, y, v)≈ret_{std}(θ, v) is established, an operation load may be reduced by an operation using the standard liquid crystal retardance characteristic ret_{std}Δ(θ, v) in calculating the calibration data ret_{calib}(x, y, v).

That is, since it is possible to regard that a relationship of ret_{calib}(x, y, v)≈ret_{std}(θ, v) is established, and it can be assumed that the difference changes only gently with respect to the voltage change, the calibration data ret_{calib}(x, y, v) is defined as a value obtained by addition of a minute term to the standard liquid crystal retardance characteristic ret_{std}Δ(θ, v), and an operation is performed substantially with the minute term as the calibration data, whereby a load related to the operation of the calibration data may be reduced.

Note that, the calibration data ret_{calib}(x, y, v) has a configuration corresponding to the retardance as described above, and thus may be expressed by a transmittance according to a voltage or a focal length, expressing the phase difference.

### <Chart>

Next, with reference to FIG. 8, a description will be given of examples of charts imaged in the states where the known lens 113S and the target lens 113C are respectively mounted on the lens mount 112 at the time of the calibration processing.

The chart is, for example, as illustrated in FIG. 8.

In the chart 171 of FIG. 8, three markers 181-1 to 181-3 are provided.

In the calibration processing, the chart 171 as illustrated in FIG. 8 is imaged in the states where the known lens 113S and the target lens 113C are respectively mounted on the lens mount 112.

In order to easily grasp a positional relationship between images captured in the states where the known lens 113S and the target lens 113C are respectively mounted on the lens mount 112, the markers 181-1 to 181-3 are provided. Note that, hereinafter, the markers 181-1 to 181-3 will be simply referred to as the markers 181 in a case where it is not particularly necessary to distinguish them from each other.

Although the chart 171 of FIG. 8 is merely an example, it is desirable to have a configuration based on white in order to capture as much spectral information as possible, but a configuration including a color other than white may be used.

Furthermore, the specific shape and arrangement of the markers 181 in FIG. 8 are merely examples, but in order to facilitate alignment between images obtained by imaging of the same chart 171 from different positions, the markers 181 are arranged on the inner side of the chart 171 to some extent, and the plurality of markers 181 are made not to have a line-symmetric or point-symmetric shape or arrangement (to have asymmetric shape or arrangement).

As described above, by causing the shape and arrangement of the markers 181 not to be line-symmetric or point-symmetric (to be asymmetrical), it is possible to facilitate alignment including rotation between images captured in cases where the known lens 113S and the target lens 113C are respectively mounted.

Furthermore, in a case where angles of view are different between images captured in the cases where the known lens 113S and the target lens 113C are respectively mounted, imaging is repeated a plurality of times while the imaging direction is changed to make it possible to acquire spectral information of the entire image.

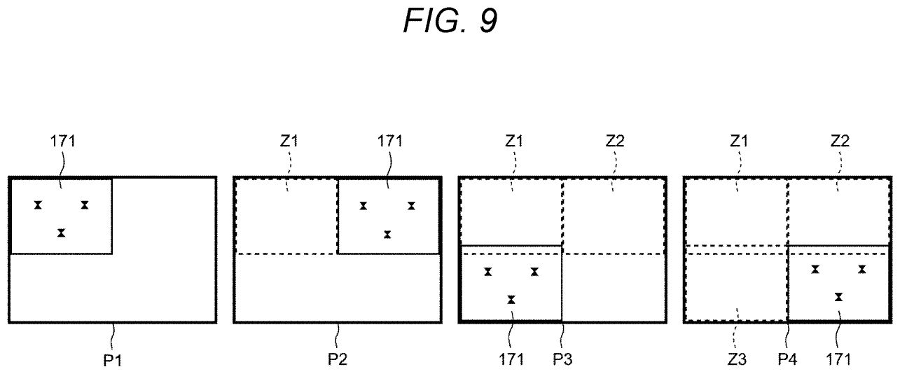

For example, in a case where the angle of view of the target lens 113C is wider than the angle of view of the known lens 113S, as illustrated in FIG. 9, imaging is repeated a plurality of times while the imaging direction is changed, whereby the entire angle of view is covered of the image captured when the target lens 113C is mounted.

FIG. 9 illustrates an imaging example of images P1 to P4 when the chart 171 is imaged four times in the state where the target lens 113C is mounted, in order from the left.

That is, first, in the state where the known lens 113S is mounted, an image is captured such that the chart 171 covers the entire angle of view.

Next, the known lens 113S is removed, the target lens 113C is mounted on the lens mount 112, and imaging with the target lens 113C is started.

At this time, since it is desirable to image the chart 171 under a condition close to a condition under which the spectral information is obtained with the known lens 113S, it is desirable that the spectral imaging system 101 image the chart 171 in a positional relationship substantially the same as a positional relationship in which the chart 171 is imaged with the known lens 113S.

Then, for example, in the first imaging, as indicated by the image P1, imaging is performed in an imaging direction in which the chart 171 is imaged in the upper left portion of the image P1.

Next, in the second imaging, as indicated by the image P2, the imaging direction is changed to perform imaging so that the chart 171 is imaged on the right side from a region Z1 in the upper left portion of the image P1 where the chart 171 is imaged.

Furthermore, in the third imaging, as indicated by the image P3, the imaging direction is changed to perform imaging so that the chart 171 is imaged on the lower left side from the regions Z1 and Z2 of the images P1 and P2 where the chart 171 is imaged.

Then, in the fourth imaging, as indicated by the image P4, the imaging direction is changed to perform imaging so that the chart 171 is imaged on the lower right side other than the regions Z1 to Z3 of the images P1 to P3 where the chart 171 is imaged.

That is, as illustrated in FIG. 9, by the images P1 to P4 obtained by four times of imaging, the chart 171 is imaged in an entire region within the angle of view of the target lens 113C.

### <Calibration Processing>

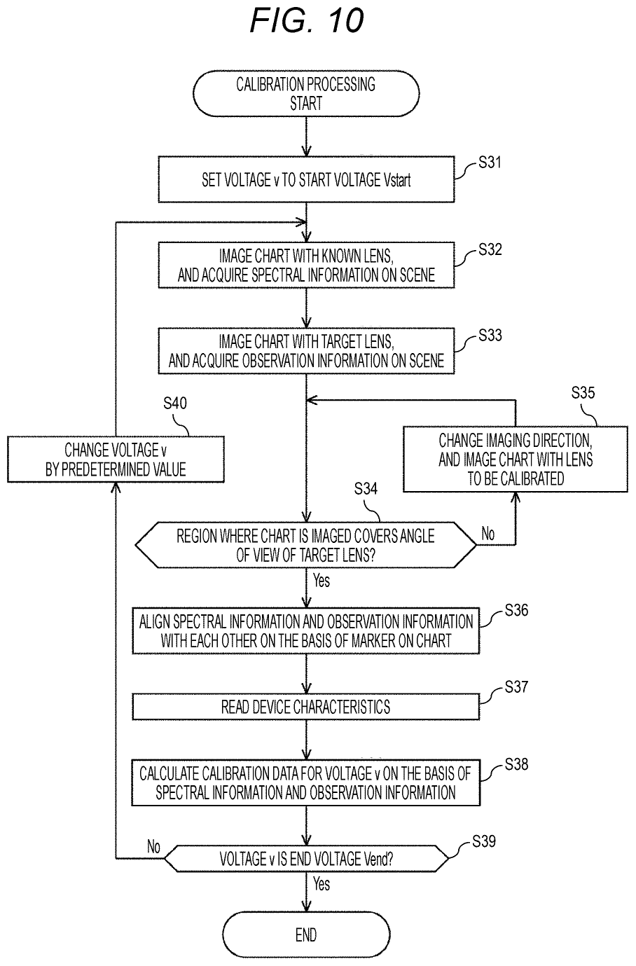

Next, with reference to a flowchart in FIG. 10, a description will be given of the calibration processing by the spectral imaging system 101 in FIG. 6. Note that, here, the description will be given on the premise that the target lens 113C is a short focal lens and the focal length is constant.

In step S31, the calibration processing unit 151 of the control unit 135 controls the liquid crystal control unit 136 to cause the applied voltage v to the liquid crystal device 132 to be set to a start voltage Vstart (for example, a minimum voltage or a maximum voltage). In response to this, the liquid crystal control unit 136 sets the applied voltage v to the liquid crystal device 132 to the start voltage Vstart.

In step S32, the calibration processing unit 151 images the chart 171 in the state where the known lens 113S is mounted, generates the spectral information h(x, y, λ) of the scene on the basis of the modulated image that is the imaging result, and stores the spectral information in the data recording unit 139.

More specifically, the calibration processing unit 151 controls, for example, the presentation unit 142 (not illustrated) to present information for prompting the user to mount the known lens 113S by an image, sound, or the like.

Then, when the lens control unit 137 acquires the lens ID by lens-camera communication or the like, indicates that the lens 113 mounted on the lens mount 112 is the known lens 113S, and the user operates the operation unit 141 including a shutter button or the like in a state where the entire angle of view of the chart 171 is covered, the calibration processing unit 151 controls the imaging element 134 to capture an image, generates the spectral information h(x, y, λ) on the basis of the modulated image that is the imaging result, and stores the spectral information in the data recording unit 139.

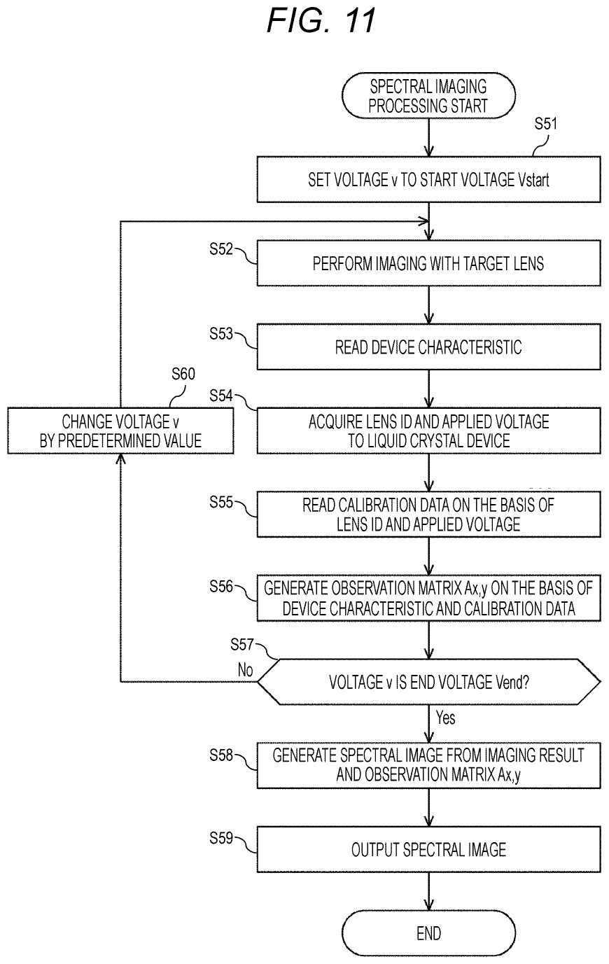

Note that processing of generating the spectral information h(x, y, λ) is specifically processing itself of generating a spectral image using known calibration data by processing similar to the spectral imaging processing to be described later with reference to a flowchart of FIG. 11. For this reason, description of the processing here is omitted.

In step S33, the calibration processing unit 151 images the chart 171 in the state where the target lens 113C is mounted, and generates the observation information i(x, y, v) of the scene on the basis of the imaging result.

More specifically, the calibration processing unit 151 uses the presentation unit 142 to present information for prompting the user to mount the target lens 113C with an image, sound, or the like.

Then, when the lens control unit 137 acquires the lens ID of the target lens 113C by lens-camera communication or the like and the user operates the operation unit 141 including the shutter button or the like in a state where the chart 171 is included in the angle of view, the calibration processing unit 151 controls the imaging element 134 to capture an image and generates the observation information i(x, y, v) on the basis of the modulated image that is the imaging result.

Note that, at this time, the lens control unit 137 acquires information of the focal length and the focus position of the target lens 113C, and supplies the information to the calibration data storage unit 138 together with the lens ID.

In step S34, the calibration processing unit 151 determines whether or not a region where the chart 171 is imaged in the image captured in the state where the target lens 113C is mounted covers the entire angle of view imaged with the target lens 113C.

More specifically, as described with reference to FIG. 9, it is determined whether or not the region of the chart 171 in the image captured in the state where the target lens 113C is mounted covers the entire region within the angle of view of the image captured in the state where the target lens 113C is mounted.

Here, as described with reference to FIG. 9, in a case where the angle of view when the target lens 113C is mounted is larger than an imaging region of the chart 171, the calibration processing unit 151 may recognize the region of the chart 171 in the image that is the imaging result and determine whether or not the entire region within the angle of view is covered.

In step S34, in a case where it is determined that the region of the chart 171 in the image captured in the state where the target lens 113C is mounted does not cover the entire region within the angle of view of the image captured in the state where the target lens 113C is mounted, the processing proceeds to step S35.

In step S35, when an instruction is given to perform imaging after the imaging direction is changed, the calibration processing unit 151 controls the imaging element 134 to capture an image, generates the observation information i(x, y, v) on the basis of the modulated image that is the imaging result, and the processing returns to step S34.

More specifically, the calibration processing unit 151 causes the presentation unit 142 to present, to the user, an image or sound for prompting imaging with the imaging direction changed such that the region of the chart 171 in the image captured in the state where the target lens 113C is mounted covers the entire region within the angle of view of the image captured in the state where the target lens 113C is mounted.

At this time, in the presentation unit 142, for example, an image may be presented in which a region where the chart 171 has been imaged and a region where the chart has not been imaged can be identified within the angle of view imaged in the state where the target lens 113C is mounted, to allow the user to easily recognize a direction in which imaging is to be performed.

As described above, when the user changes the imaging direction on the basis of the information presented by the presentation unit 142 and operates the operation unit 141 as the shutter button, the calibration processing unit 151 controls the imaging element 134 to capture an image and generates the observation information i(x, y, v) on the basis of the modulated image that is the imaging result.

That is, the processing in steps S34 and S35 is repeated until it is determined that the region where the chart 171 is imaged in the image captured in the state where the target lens 113C is mounted covers the entire angle of view imaged with the target lens 113C.

Then, in step S35, in a case where it is determined that the region where the chart 171 is imaged in the image captured in the state where the target lens 113C is mounted covers the entire angle of view imaged with the target lens 113C, the processing proceeds to step S36.

In step S36, the calibration processing unit 151 aligns the spectral information h(x, y, λ) and the observation information i(x, y, v) with each other on the basis of the markers 181 provided in the chart 171.

In step S37, the calibration processing unit 151 reads the standard liquid crystal retardance characteristic ret_{std}(θ, v) and the spectral sensitivity characteristic s(λ) as device characteristics from the device characteristic data storage unit 140.

In step S38, the calibration processing unit 151 calculates the calibration data ret_{calib}(x, y, v) satisfying the relationship of Expression (4) described above by using the read standard liquid crystal retardance characteristic ret_{std}(θ, v) and spectral sensitivity characteristic s(λ), and the aligned spectral information h(x, y, λ) and observation information i(x, y, v).

Then, the calibration processing unit 151 stores, in the calibration data storage unit 138, the calibration data ret_{calib}(x, y, v) as a calculation result.

At this time, the calibration data ret_{calib}(x, y, v) is stored in the calibration data storage unit 138 in association with information such as the applied voltage v to the liquid crystal device 132 at that time, the lens ID, the focal length, and the focus position.

In step S39, the calibration processing unit 151 determines whether or not the applied voltage v is an end voltage Vend (for example, the maximum voltage or the minimum voltage), and in a case where the applied voltage v is not the end voltage Vend, the processing proceeds to step S40.

In step S40, the calibration processing unit 151 changes (adds or subtracts) the applied voltage v by a predetermined value, the processing returns to step S32, and the processing in step S32 and subsequent steps is repeated.

Then, in step S39, in a case where it is determined that the applied voltage v is the end voltage Vend and it is determined that the calibration data ret_{calib}(x, y, v) has been calculated for all the applied voltages v to the liquid crystal device 132, the processing ends.

By the above processing, the calibration data ret_{calib}(x, y, v) of all the applied voltages v to the liquid crystal device 132 are calculated and stored in the calibration data storage unit 138.

At this time, the user can obtain the calibration data ret_{calib}(x, y, v) only by imaging the chart 171 in the states where the known lens 113S and the target lens 113C are respectively mounted.

Note that, in the above description, an example has been described in which the target lens 113C is a short focal lens, and the calibration data ret_{calib}(x, y, v) is obtained while the applied voltage v to the liquid crystal device 132 is changed in a state where the focal length is fixed.

However, in a case where the target lens 113C is a zoom lens or the like and the focal length is variable, it is necessary to obtain the calibration data ret_{calib}(x, y, v) while changing not only the applied voltage v but also the focal length.

In this case, required is a processing loop for changing the focal length corresponding to a processing loop for changing the applied voltage v in steps S31, S39, and S40.

Furthermore, at this time, the obtained calibration data ret_{calib}(x, y, v) is generated according to the applied voltage v and the focal length, and is stored in the calibration data storage unit 138 in association with the applied voltage v and the focal length.

Moreover, in the above description, the known lens 113S and the target lens 113C are interchanged every time the applied voltage v to the liquid crystal device 132 is changed, but the number of times of interchange is large and troublesome.

Thus, the chart 171 may be imaged with the applied voltage v to the liquid crystal device 132 changed in the state where the known lens 113S is mounted, and the spectral information h(x, y, λ) of all the voltages v (and all the focal lengths) may be recorded in the data recording unit 139, and thereafter, interchange may be performed with the target lens 113C, the observation information i(x, y, v) may be acquired while all the voltages v (and all the focal lengths) are changed, the calibration data ret_{calib}(x, y, v) may be sequentially obtained, and the calibration data may be stored in the calibration data storage unit 138.

In this way, the interchange of the known lens 113S and the target lens 113C can be completed by only one interchange.

### <Spectral Imaging Processing>

Next, with reference to a flowchart in FIG. 11, a description will be given of the spectral imaging processing by the spectral imaging system 101 in FIG. 6.

Note that this processing is based on the premise that the calibration processing described above has been completed and the calibration data ret_{calib}(x, y, v) has been stored in the calibration data storage unit 138.

In step S51, the spectral imaging processing unit 152 of the control unit 135 controls the liquid crystal control unit 136 to cause the applied voltage v to the liquid crystal device 132 to be set to the start voltage Vstart (for example, the minimum voltage or the maximum voltage). In response to this, the liquid crystal control unit 136 sets the applied voltage v to the liquid crystal device 132 to the start voltage Vstart.

In step S52, when the operation unit 141 including a shutter button or the like is operated in the state where the target lens 113C is mounted, the spectral imaging processing unit 152 of the control unit 135 controls the imaging element 134 to capture an image and acquire an imaging result.

In step S53, the spectral imaging processing unit 152 reads the spectral sensitivity characteristic s(λ) as the device characteristic from the device characteristic data storage unit 140 from the device characteristic data storage unit 140.

In step S54, the spectral imaging processing unit 152 acquires information of the applied voltage v to the liquid crystal device 132 from the liquid crystal control unit 136, and acquires the lens ID of the target lens 113C mounted on the lens mount 112 from the lens control unit 137.

In step S55, the spectral imaging processing unit 152 accesses the calibration data storage unit 138 and reads the corresponding calibration data ret_{calib}(x, y, v) on the basis of the lens ID and the applied voltage v to the liquid crystal device 132.

In step S56, the spectral imaging processing unit 152 calculates the observation matrix A_{x,y}(v, λ) of Expression (5) described above expressing a voltage wavelength sensitivity characteristic on the basis of the spectral sensitivity characteristic s(λ) as the device characteristic and the calibration data ret_{calib}(x, y, v).

In step S57, the spectral imaging processing unit 152 determines whether or not the applied voltage v is the end voltage Vend (for example, the maximum voltage or the minimum voltage), and in a case where the applied voltage v is not the end voltage Vend, the processing proceeds to step S60.

In step S60, the spectral imaging processing unit 152 changes (adds or subtracts) the applied voltage v by a predetermined value, the processing returns to step S52, and the processing in step S52 and subsequent steps is repeated.

Then, in step S57, in a case where it is determined that the applied voltage v is the end voltage Vend and it is determined that the observation matrix A_{x,y}(v, λ) has been calculated for all the applied voltages v to the liquid crystal device 132, the processing proceeds to step S58.

In step S58, the spectral imaging processing unit 152 generates the observation matrix A on the basis of the observation matrix A_{x,y}(v, λ) for all the voltages, and generates a spectral image by a matrix operation corresponding to Expression (3) described above from the modulated image as the imaging result and the observation matrix A expressing the voltage wavelength sensitivity characteristic.

In step S59, the spectral imaging processing unit 152 outputs the generated spectral image from an external output or records the spectral image in the data recording unit 139.

With the above processing, even in the spectral imaging using the liquid crystal device and the polarizing element, it is possible to interchange with any lens to be used.

Note that, in the above, an example has been described in which the calibration data ret_{calib}(x, y, v) is selected on the basis of the lens ID and the applied voltage v to the liquid crystal device 132, the observation matrix A_{x,y}(v, λ) is calculated, and a spectral image is captured.

However, in a case where the target lens 113C is a zoom lens or the like and the focal length changes, in addition to the lens ID and the applied voltage v, the calibration data ret_{calib}(x, y, v) according to the focal length is calculated in advance, whereby it is possible to set the observation matrix A_{x,y}(v, λ) according to the lens ID, the applied voltage v to the liquid crystal device 132, and the focal length.

That is, in a case where the target lens 113C is a zoom lens or the like and the focal length varies, in the processing of step S53, the spectral imaging processing unit 152 acquires information of the applied voltage v to the liquid crystal device 132 from the liquid crystal control unit 136, and acquires the lens ID and the focal length of the target lens 113C mounted on the lens mount 112 from the lens control unit 137.

Then, in step S54, the spectral imaging processing unit 152 accesses the calibration data storage unit 138, and reads the corresponding calibration data ret_{calib}(x, y, v) on the basis of the lens ID, the focal length, and the applied voltage v to the liquid crystal device 132.

In summary, in the spectral imaging using the liquid crystal device and the polarizing element, at the time of lens interchange or angle-of-view change, the calibration is performed such that the same chart is imaged with use of the calibrated lens and an unknown lens (lens that has not been calibrated) while the applied voltage to the liquid crystal device and, as necessary, the focal length are changed, the respective pieces of spectral information and the observation information are acquired, and the calibration data is obtained so that both match each other.

Then, the voltage wavelength sensitivity characteristic based on the liquid crystal device and the polarizing element in the case of using the unknown lens is obtained with use of the calibration data, and the spectral image is generated by the observation matrix to which the obtained voltage wavelength sensitivity characteristic is applied with respect to the modulated image modulated by the liquid crystal device and the polarizing element with use of the unknown lens.

As a result, any various lenses can be used for the spectral imaging using the liquid crystal device and the polarizing element, and it is possible to implement a spectral imaging system with a high degree of freedom, supporting dynamic angle-of-view change in conjunction with lens interchange or a change in focal length due to zooming.

Note that the present disclosure can also have the following configurations.

<1> A calibration method for a spectral imaging system that generates spectral information with use of a lens, a liquid crystal device, and a polarizing element, the calibration method including a step of
generating calibration data for a target lens that is the lens to be calibrated, the calibration data matching observation information corresponding to the spectral information generated with use of the target lens with a true value of the spectral information.

<2> The calibration method according to <1>, in which the liquid crystal device and the polarizing element modulate incident light incident through the lens to generate modulated light, to generate a modulated image including the modulated light, and the spectral information is generated from the modulated image and the calibration data.

<3> The calibration method according to <2>, in which
the spectral information is generated on the basis of a plurality of the modulated images for respective applied voltages varied from each other, the modulated images being generated by the applied voltages applied to the liquid crystal device, and modulation characteristics of the liquid crystal device and the polarizing element according to a change in the applied voltages, and
the calibration data is applied to the modulation characteristics.

<4> The calibration method according to <3>, in which
the spectral information is generated by a matrix operation using a matrix having pixel values constituting the plurality of the modulated images for the respective applied voltages as elements and an observation matrix corresponding to the modulation characteristics, and
the calibration data is applied to elements constituting the observation matrix.

<5> The calibration method according to <1>, in which the calibration data is generated such that observation information generated from an image in which a chart that is a reference subject is imaged with use of the target lens matches spectral information generated from an image in which the same chart is imaged with use of a known lens that is the lens having been calibrated.

<6> The calibration method according to <5>, in which in a case where an angle of view related to imaging using the target lens is wider than an angle of view related to imaging using the known lens, the observation information is generated from an image in which the chart is imaged to cover a whole of the angle of view related to imaging using the target lens.

<7> The calibration method according to <6>, in which the observation information is generated from an image in which the chart is imaged to cover the whole of the angle of view related to imaging using the target lens by imaging performed with an imaging direction changed a plurality of times.

<8> The calibration method according to <7>, in which
the chart includes markers for alignment, and
an image in which the chart is imaged with use of the target lens and an image in which the chart is imaged with use of the known lens are aligned on the basis of the markers.

<9> The calibration method according to <8>, in which the markers are arranged near the center of the chart, and shapes and arrangement of the markers are asymmetric.

<10> The calibration method according to <2>, in which the calibration data is a value based on a birefringence index of the liquid crystal device, the birefringence index being set in association with coordinates on the modulated image and an applied voltage to the liquid crystal device.

<11> The calibration method according to <10>, in which the calibration data is a value obtained by multiplication of the birefringence index of the liquid crystal device by a thickness of the liquid crystal device, the birefringence index being set in association with the coordinates on the modulated image and the applied voltage to the liquid crystal device.

<12> The calibration method according to <10>, in which the calibration data is set by addition of a minute term to a retardance (phase difference) set in accordance with an incident angle of a principal ray of the liquid crystal device, the incident angle being enabled to be handled in an approximate manner to the birefringence index of the liquid crystal device and corresponding to the coordinate on the modulated image, the birefringence index being set in association with the coordinates on the modulated image and the applied voltage to the liquid crystal device.

<13> The calibration method according to <10>, in which the calibration data is held as a representative of a plurality of sample points in a two-dimensional pixel space on the modulated image.

<14> The calibration method according to <13>, in which the calibration data between the sample points is generated by interpolation.

<15> The calibration method according to <1>, in which
the polarizing element includes a first polarizing element and a second polarizing element provided at a front stage and a rear stage of the liquid crystal device,
the first polarizing element transmits polarized light forming a positive angle of 45 degrees with respect to a fast axis of the liquid crystal device, and
the second polarizing element transmits polarized light forming a negative angle of 45 degrees with respect to the fast axis of the liquid crystal device.

### REFERENCE SIGNS LIST

101 Spectral imaging system
111 Imaging processing unit
112 Lens mount
113 Lens
113S Known lens
113C Target lens
130 Spectral optical block
131 Polarizing element
132 Liquid crystal device
133 Polarizing element
134 Imaging element
135 Control unit
136 Liquid crystal control unit
137 Lens control unit
138 Calibration data storage unit
139 Data recording unit
140 Device characteristic data storage unit
141 Operation unit
142 Presentation unit
151 Calibration processing unit
152 Spectral imaging unit
171 Chart
181, 181-1 to 181-3 Marker

What is claimed is:

1. A calibration method for a spectral imaging system that generates spectral information with use of a lens, a liquid crystal device, and a polarizing element, the calibration method comprising a step of
generating calibration data for a target lens that is the lens to be calibrated, the calibration data matching observation information corresponding to the spectral information generated with use of the target lens with a true value of the spectral information.

2. The calibration method according to claim 1, wherein the liquid crystal device and the polarizing element modulate incident light incident through the lens to generate modulated light, to generate a modulated image including the modulated light, and the spectral information is generated from the modulated image and the calibration data.

3. The calibration method according to claim 2, wherein
the spectral information is generated on a basis of a plurality of the modulated images for respective applied voltages varied from each other, the modulated images being generated by the applied voltages applied to the liquid crystal device, and modulation characteristics of the liquid crystal device and the polarizing element according to a change in the applied voltages, and
the calibration data is applied to the modulation characteristics.

4. The calibration method according to claim 3, wherein
the spectral information is generated by a matrix operation using a matrix having pixel values constituting the plurality of the modulated images for the respective applied voltages as elements and an observation matrix corresponding to the modulation characteristics, and
the calibration data is applied to elements constituting the observation matrix.

5. The calibration method according to claim 1, wherein the calibration data is generated such that observation information generated from an image in which a chart that is a reference subject is imaged with use of the target lens matches a true value of spectral information generated from an image in which the same chart is imaged with use of a known lens that is the lens having been calibrated.

6. The calibration method according to claim 5, wherein in a case where an angle of view related to imaging using the target lens is wider than an angle of view related to imaging using the known lens, the observation information is generated from an image in which the chart is imaged to cover a whole of the angle of view related to imaging using the target lens.

7. The calibration method according to claim 6, wherein the observation information is generated from an image in which the chart is imaged to cover the whole of the angle of view related to imaging using the target lens by imaging performed with an imaging direction changed a plurality of times.

8. The calibration method according to claim 7, wherein
the chart includes markers for alignment, and
an image in which the chart is imaged with use of the target lens and an image in which the chart is imaged with use of the known lens are aligned on a basis of the markers.

9. The calibration method according to claim 8, wherein the markers are arranged near a center of the chart, and shapes and arrangement of the markers are asymmetric.

10. The calibration method according to claim 2, wherein the calibration data is a value based on a birefringence index of the liquid crystal device, the birefringence index being set in association with coordinates on the modulated image and an applied voltage to the liquid crystal device.

11. The calibration method according to claim 10, wherein the calibration data is a value obtained by multiplication of the birefringence index of the liquid crystal device by a thickness of the liquid crystal device, the birefringence index being set in association with the coordinates on the modulated image and the applied voltage to the liquid crystal device.

12. The calibration method according to claim 10, wherein the calibration data is set by addition of a minute term to a retardance (phase difference) set in accordance with an incident angle of a principal ray of the liquid crystal device, the incident angle being enabled to be handled in an approximate manner to the birefringence index of the liquid crystal device and corresponding to the coordinate on the modulated image, the birefringence index being set in association with the coordinates on the modulated image and the applied voltage to the liquid crystal device.

13. The calibration method according to claim 10, wherein the calibration data is held as a representative of a plurality of sample points in a two-dimensional pixel space on the modulated image.

14. The calibration method according to claim 13, wherein the calibration data between the sample points is generated by interpolation.

15. The calibration method according to claim 1, wherein
the polarizing element includes a first polarizing element and a second polarizing element provided at a front stage and a rear stage of the liquid crystal device,
the first polarizing element transmits polarized light forming a positive angle of 45 degrees with respect to a fast axis of the liquid crystal device, and
the second polarizing element transmits polarized light forming a negative angle of 45 degrees with respect to the fast axis of the liquid crystal device.
